(19) United States
(12) Patent Application Publication
(10) Pub. No.: US 2006/0092985 A1
(43) Pub. Date: May 4, 2006

(54) Method of transmitting time-critical information in a synchronous ethernet system

(75) Inventors: Jae-Hun Cho, Seoul (KR); Jun-Ho Koh, Suwon-si (KR); Jong-Kwon Kim, Gunpo-si (KR); Chang-Sup Shim, Seoul (KR); Yun-Je Oh, Yongin-si (KR); Sang-Mo Hong, Goyang-si (KR); Jong-Ho Yoon, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/247,514

(22) Filed: Oct. 11, 2005

(30) Foreign Application Priority Data
Oct. 29, 2004 (KR) 2004-87307

(51) Int. Cl. H04J 3/12

(52) U.S. Cl. 370/528

(57) ABSTRACT

A method of enabling transmission of a time-critical control signal event in a sync frame period, such as a pause signal that is generated when the receive buffer of an Ethernet switch is filled with packets beyond a threshold due to congestion of uplink asynchronous data, is disclosed. To transmit time-critical information in a synchronous Ethernet system, a current transmission period is checked upon detection of a time-critical event. If the current transmission period is a sync frame period, time-critical control information is generated, inserted into the first sub-sync frame after the time-critical event, and transmitted. If the current transmission period is an async frame period, a control frame including the time-critical control information is generated and transmitted.

### CLAIM OF PRIORITY

This application claims priority under 35 U.S.C. § 119 to an application entitled “Method of Transmitting Time-Critical Information in a Synchronous Ethernet System”, filed in the Korean Intellectual Property Office on Oct. 29, 2004 and assigned Serial No. 2004-87307, the contents of which are incorporated herein by reference.

### BACKGROUND OF THE INVENTION

1. Field of the Invention

The present invention relates generally to a synchronous Ethernet system, and in particular, to a method of enabling transmission of a time-critical control signal that may be in a sync frame period, such as a pause signal that is generated when the receive buffer of an Ethernet switch is filled with packets beyond a threshold due to congestion of uplink asynchronous data.

2. Description of the Related Art

Ethernet is one of the most widely used LAN (Local Access Network) technologies. It has become standardized as IEEE (Institute of Electrical and Electronics Engineers) 802.3.

Ethernet devices typically access the network competitively using a CSMA/CD (Carrier Sense Multiple Access/Collision Detect) protocol that conforms to IEEE 802.3. The devices send upper-layer service frames as Ethernet frames with IFG (Inter frame Gap) in between. Notably, the upper service frames are delivered in the order of their generation irrespective of their types.

Although it was known that the Ethernet is not suitable for carrying time delay-sensitive data such as moving pictures and voice, techniques for transmitting synchronous data like video and audio data in the conventional Ethernet being studied. This type of Ethernet is called a synchronous Ethernet.

The synchronous Ethernet sends frames on a cycle-by-cycle basis. Typically, one cycle is defined as 125 μs and divided into a sync frame period and an async frame period. The sync frame has a fixed length and the async frame has a variable length.

Because the sync frame carries data in a format of a predetermined size, it is not possible to send a control signal in the sync frame. Accordingly, when a time-critical control signal is generated, processing this control signal becomes a challenging task. This task will be described in greater detail below.

FIGS. 1A and 1B are exemplary views illustrating generation and transmission of a pause frame in a conventional Ethernet system.

Referring to FIGS. 1A and 1B, in the conventional Ethernet system, a device 10 (device A) sends downlink signals 108 to 112 to a device 11 (device B) and a device 12 (device C). Device B and device C send uplink signals 101 to 107 to device A. An Ethernet switch 13 switches among device A, device B and device C.

The Ethernet switch 13 includes a receive buffer 131 for temporarily buffering the uplink signals 103 and 104 from device B and the uplink signals 105, 106 and 107 from device C so that the uplink signals can be sequentially output.

In the case where data is filled in the receive buffer 131 at an acceptable level as illustrated in FIG. 1A, there is no need for controlling the rate of the uplink signals. On the other hand, if data is filled in the receiver buffer 131 beyond a threshold, the Ethernet switch 13 sends a pause signal 100 to device A and device A then generates a pause frame 113. This is done to control/inform devices B and C not to send uplink signals for a predetermined period of time.

The pause frame 113 is a control frame for explicit flow control in the MAC (Media Access Control) layer. When a receiving Ethernet device cannot keep up with the amount of packet data received from a transmitting counterpart because its receive buffer is filled beyond a threshold, it sends the pause frame 113 to inhibit transmission of data frames from the transmitting Ethernet device.

FIG. 2 illustrates the structure of a transmission cycle in a typical synchronous Ethernet.

Referring to FIG. 2, one cycle 20 for data transmission is 125 μs in a typical synchronous Ethernet system. The cycle 20 is divided into a sync frame period 200 for transmission of synchronous data and an async frame period 210 for transmission of asynchronous data.

The sync frame period 200 takes priority over the async frame period 210 in the cycle 20. The sync frame period 210 may include 738-byte sub-sync frames 201 to 204. It should be understood, however, that the number of bytes may be changed.

The async frame period 210 includes sub-async frames 211, 212 and 213, each of a variable size.

If a time-critical control signal needs to be transmitted in the cycle as illustrated in FIG. 1, the existing synchronous Ethernet system can deliver the time-critical control signal only in the async frame period 210. Therefore, delivery of the time-critical control signal in the sync frame period 200 always involves time delay. As a result, the time-critical control signal may not arrive in time to prevent data loss.

FIG. 3 exemplarily illustrates generation and transmission of a pause frame being a time-critical control signal in the typical synchronous Ethernet system.

Referring to FIG. 3, when a pause event occurs in an async frame period 32, a pause frame is sent in a normal way illustrated in FIG. 1B. If a pause event 301 occurs in a sync frame period 31, a pause frame, however, cannot be sent in the sync frame period 31. This means that an Ethernet device must wait until the sync frame period 31 elapses so that a pause frame 302 in the async frame period 32 can be generated. In this case, a time difference of Δt 303 exists between a pause event occurring time 301 and a pause frame generation time 302.

Considering the pause event is created when packets are filled up to a threshold in a receive buffer, buffer overflow during Δt causes transmission loss of the uplink async frame. Accordingly, a need exists in the art a method of sending time critical (e.g., pause) information in the sync frame period 31 without producing the time difference of Δt 303.

### SUMMARY OF THE INVENTION

One aspect of the present invention relates to a time-critical information transmitting method in a synchronous Ethernet system that prevents loss of uplink data in a receive buffer by transmitting pause information in a conventional pause frame for an async frame period or by allowing transmission of the pause information for a sync frame period, if asynchronous traffic is congested on the uplink.

One embodiment of the present invention is directed to a method of enabling transmission of a time-critical control signal even in a sync frame period, such as a pause signal that is generated when the receive buffer of an Ethernet switch is filled with packets beyond a threshold due to congestion of uplink asynchronous data. To transmit time-critical information in a synchronous Ethernet system, a current transmission period is checked upon detection of a time-critical event. If the current transmission period is a sync frame period, time-critical control information is generated, inserted into the first sub-sync frame after the time-critical event, and transmitted. If the current transmission period is an async frame period, a control frame including the time-critical control information is generated and transmitted.

### BRIEF DESCRIPTION OF THE DRAWINGS

The above and other aspects, features and embodiments of the present invention will become more apparent from the following detailed description when taken in conjunction with the accompanying drawings in which:

FIG. 1 exemplarily illustrates generation and transmission of a pause frame in a conventional Ethernet system;

FIG. 2 illustrates the structure of a transmission cycle in a typical synchronous Ethernet system;

FIG. 3 exemplarily illustrates generation and transmission of a pause frame being a time-critical control signal in the typical synchronous Ethernet system;

FIG. 4 illustrates generation and transmission of a pause frame being a time-critical control signal in a synchronous Ethernet system according to an embodiment of the present invention;

FIG. 5 illustrates the structure of a pause frame in the conventional Ethernet system;

FIG. 6 illustrates the structure of a sub-sync frame for carrying the time-critical information according to an embodiment of the present invention;

FIG. 7 illustrates the structure of a sub-sync frame for carrying the time-critical information according to an alternative embodiment of the present invention; and

FIG. 8 is a flowchart illustrating a method of sending the time-critical information in the synchronous Ethernet system according to an embodiment of the present invention.

### DETAILED DESCRIPTION

Embodiments of the present invention will be described herein below with reference to the accompanying drawings. For the purposes of clarity and simplicity, well-known functions or constructions are not described in detail since they would obscure the invention in unnecessary detail.

While a pause frame is described as an event requiring time-critical control in the following description, it is only for illustrative purposes. Therefore, it is to be appreciated that time-critical OAM (Operations, Administration and Maintenance) information other than the pause frame can also be sent according embodiments of the present invention.

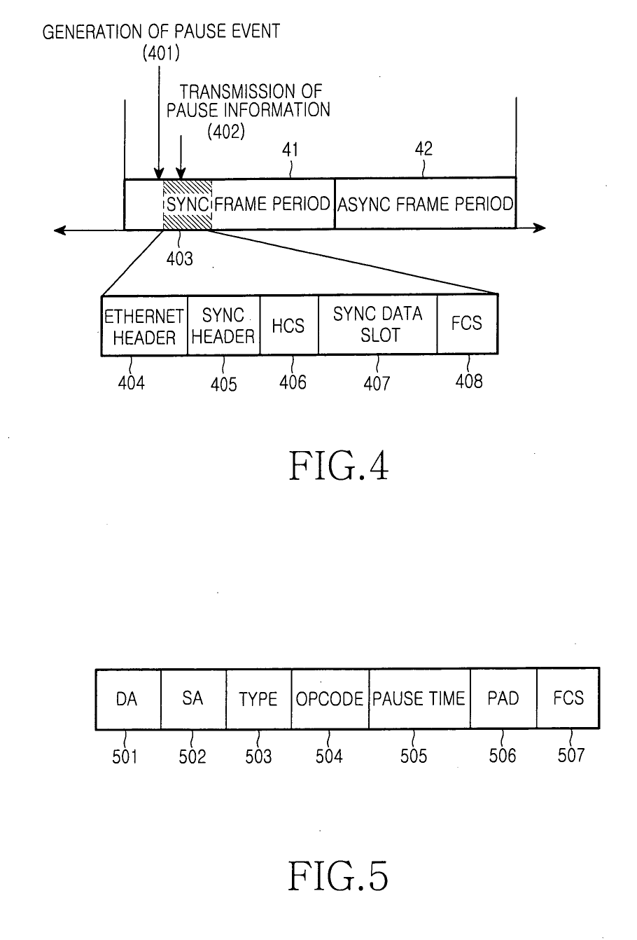

FIG. 4 illustrates generation and transmission of a pause frame being a time-critical control signal in a synchronous Ethernet system according to an embodiment of the present invention.

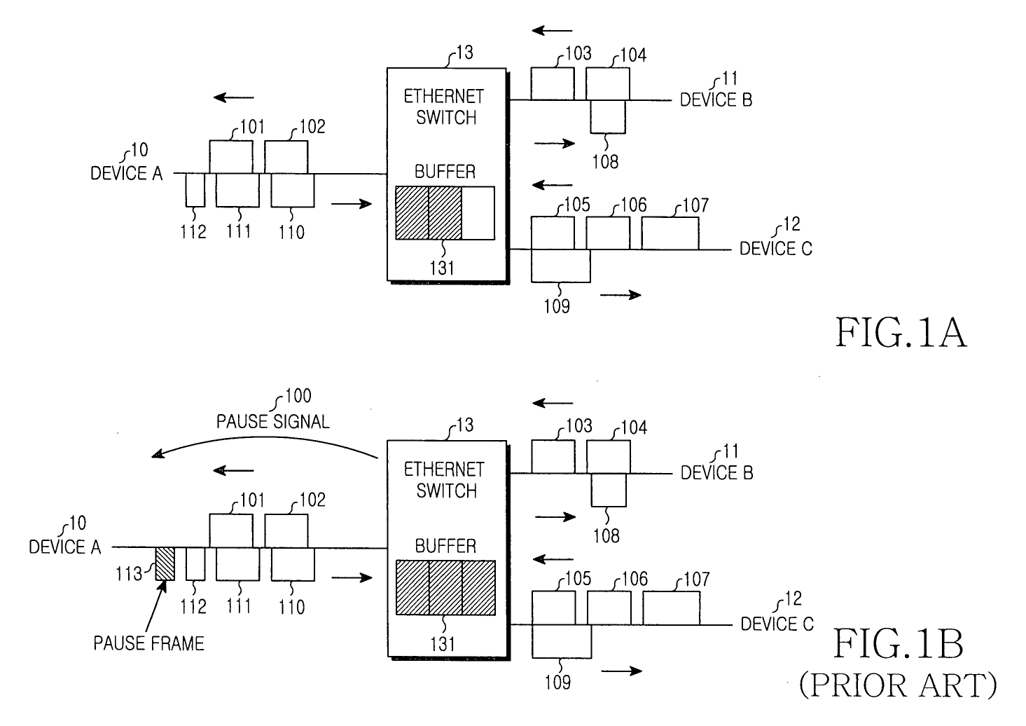

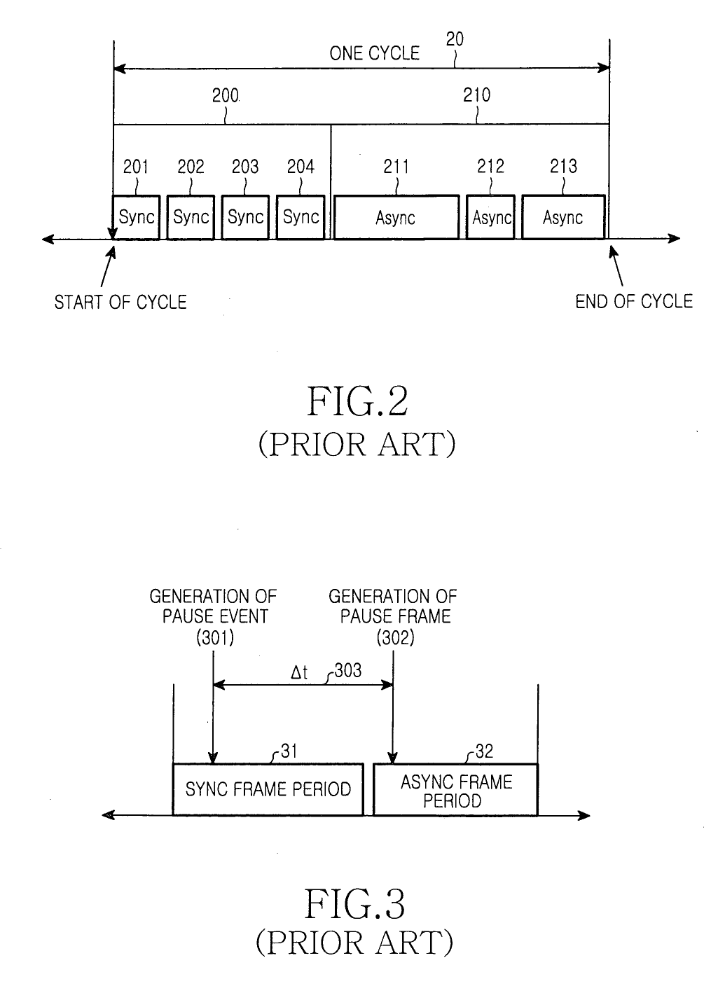

Upon generation of a pause event in an async frame period 42 of a 125-μs transmission cycle, a pause frame is generated and sent as a time-critical control signal as done in the typical Ethernet system, as illustrated in FIG. 1B. On the other hand, if a pause event 401 occurs in a sync frame period 41, pause information is sent in a sub-sync frame 403 in the sync frame period 41.

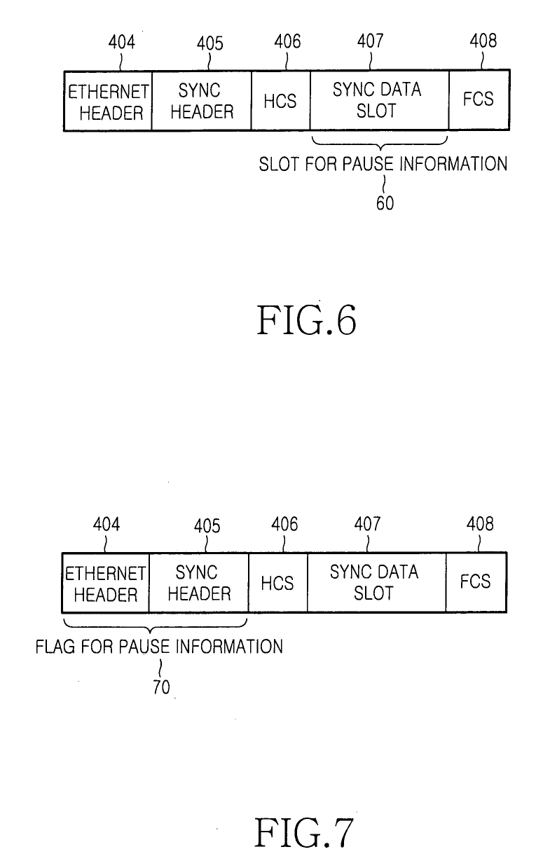

A plurality of sub-sync frames exist in the sync frame period 41. Each sub-sync frame is designed to deliver a time-critical control signal in the sync frame period 41. The structure of the sub-sync frame for carrying the time-critical control signal in the sync frame period 41 will be described in greater detail with reference to FIGS. 6 and 7.

In this embodiment of the present invention, each sub-sync frame includes a 22-byte Ethernet Header 404 with header information about the destination address, source address and type of the Ethernet frame, a 32-byte Sync Header 405 with information about the sync frame, such as information indicating synchronization or asynchronization, frame count information, cycle count information, a 4-byte HCS (Header Check Sequence) 406, a 768-byte Sync Data Slot 407 including 192 4-byte sync data slots, and a 4-byte FCS (Frame Check Sequence) 408.

FIG. 5 illustrates the structure of a pause frame in the conventional Ethernet system.

Referring to FIG. 5, the pause frame is includes a 6-byte DA (Destination Address) 501 indicating the destination of the pause frame, a 6-byte SA (Source Address) 502 indicating the source of the pause frame, a 2-byte Type 503 indicating the type of the pause frame, a 2-byte OPCODE 504 indicating the operation code of the pause frame, a 2-byte Pause Time 505 indicating the duration of a pause operation in an Ethernet device that receives the pause frame, a PAD 506 used to fill dummy bits in the remaining area according to an Ethernet frame format if the pause frame does not reach 46 bytes, and a 4-byte FCS 507 for error check in the pause frame.

The OPCODE 504 includes a control message notifying the receiving Ethernet device that the transmitted frame is a pause frame and ordering it to perform a pause operation. The Pause Time 505 tells the receiving Ethernet device the time duration of the pause operation. The Pause Time 505 represents 0 to 65535 in 512 bits. In a 1-Gbps Ethernet, the actual maximum value of a pause timer is 33.6 ms.

The receiving Ethernet device sets the pause timer to the indicated value and discontinues data transmission until the timer expires.

The time-critical information delivered in the sync frame period is confined to the OPCODE 504 and Pause Time 505 in the conventional pause frame. 4 bytes suffices for transmission of the time-critical information.

FIG. 6 illustrates the structure of a sub-sync frame for carrying the time-critical information according to an embodiment of the present invention.

Referring to FIG. 6, each sub-sync frame includes the 22-byte Ethernet Header 404 with header information about the destination address, source address and type of the Ethernet frame, the 32-byte Sync Header 405 with information about the sync frame, such as information indicating synchronization or asynchronization, frame count information, cycle count information, the 4-byte HCS 406, the 768-byte Sync Data Slot 407 including 192 4-byte sync data slots, and the 4-byte FCS 408.

In accordance with this embodiment, one (4 bytes) of sync data slots included in the Sync Data Slot 407 is allocated to carry time-critical control information.

Upon detection of a time-critical event in the sync frame period, the time-critical control information can be sent with no more than a maximum of one sub-sync frame (about 830 bytes). Compared to the conventional technology in which a time delay occurs over the entire sync frame period (about 8000 to 12000 bytes). Accordingly, the problems caused by the delay of the time-critical information are considerably reduced.

FIG. 7 illustrates the structure of a sub-sync frame for carrying the time-critical information according to an alternative embodiment of the present invention.

Referring to FIG. 7, each sub-sync frame includes the 22-byte Ethernet Header 404 with header information about the destination address, source address and type of the Ethernet frame, the 32-byte Sync Header 405 with information about the sync frame, such as information indicating synchronization or asynchronization, frame count information, cycle count information, the 4-byte HCS 406, the 768-byte Sync Data Slot 407 including 192 4-byte sync data slots, and the 4-byte FCS 408.

In accordance with the alternative embodiment of the present invention, all the contents of the OPCODE 504 and the Pause Time 505 are not sent, unlike in the conventional pause frame. Instead, information about a pause duration is set and a More Flag bit is set to carry the pause information. The receiving Ethernet device then discontinues uplink transmission for the pause time period. This is a difference from the first embodiment of the present invention.

The More Flag bit can be allocated in many ways. For example, one bit in a reserved field included in the Ethernet Header 404 or the Sync Header 405 is allocated as the More Flag bit.

Also, the More Flag bit can be allocated by modifying a specific field (i.e. Length/Type field) included in the Ethernet Header 404 or the Sync Header 405. For example, one bit of the 4-byte Length/Type field can be used as the More Flag bit.

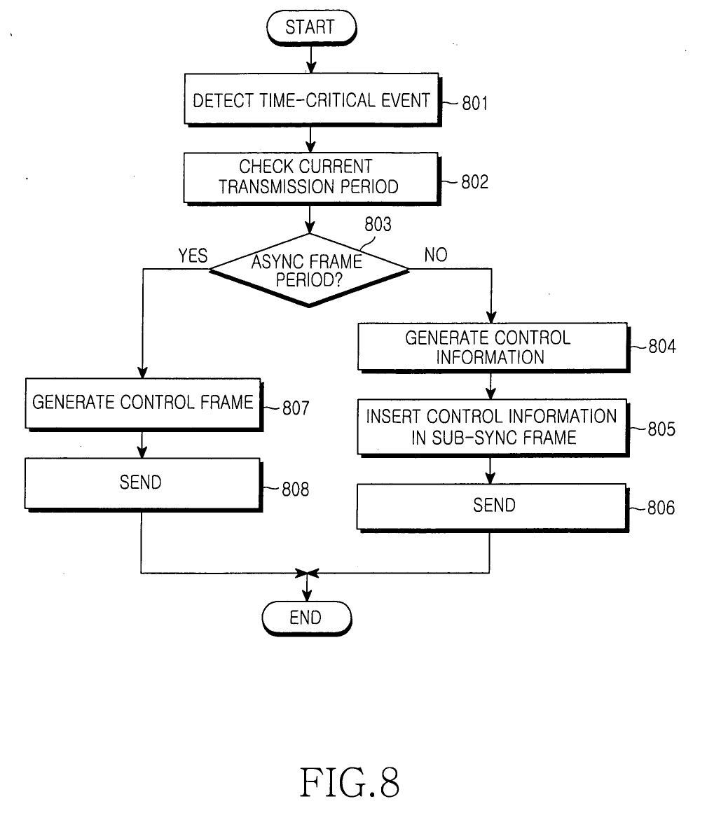

FIG. 8 is a flowchart illustrating a method of sending the time-critical information in the synchronous Ethernet system according to an embodiment of the present invention.

Referring to FIG. 8, upon detection of a time-critical event, such as a receiver buffer being filled beyond a threshold, in step 801, the current transmission period is checked in step 802.

In the case of a sync frame period, time-critical control information is generated in step 804. The time-critical control information is inserted in a sync data slot as illustrated in FIG. 6 or set as flag information indicating the presence of the time-critical control information as illustrated in FIG. 7, depending on a time-critical control information transmitting method adopted by the system.

The time-critical control information is inserted into the first sub-sync frame after the time-critical event in step 805 and sent in step 806.

On the other hand, in the case of an async frame period in step 803, a control frame with the time-critical control information is generated in step 807 and sent in step 808, as done in the conventional Ethernet.

As described above, when asynchronous traffic is congested on the uplink, a pause frame may be sent as done conventionally if a pause event occurs in an async frame period. In addition, the pause frame can also be send in a sub-sync frame if a pause event occurs in a sync frame period. Therefore, loss of the uplink data in a receiver buffer is prevented and/or reduced as compared to conventional systems.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of transmitting time-critical information in a synchronous Ethernet system, comprising the steps of:
(1) checking a current transmission period, upon detection of a time-critical event;
(2) generating time-critical control information, if the current transmission period is a sync frame period;
(3) inserting the time-critical control information into the first sub-sync frame after the time-critical event and transmitting the time-critical control information; and
(4) generating a control frame including the time-critical control information and transmitting the time-critical control information, if the current transmission period is an async frame period.

2. The method of claim 1, wherein the step of (3) includes the step of inserting the time-critical control information into one of sync data slots included in a sync data slot field of the first sub-sync frame after the time-critical event and transmitting the time-critical control information.

3. The method of claim 1, wherein the step of (3) includes the step of allocating a flag bit in a header field of the first sub-sync frame after the time-critical event, setting the flag bit to indicate the time-critical control information, and transmitting the time-critical control information.

4. The method of claim 3, wherein the flag bit is one bit in a reserved field of the header field.

5. The method of claim 3, wherein the flag bit is allocated by modifying a predetermined field of the header field.

6. The method of claim 1, wherein the time-critical event is an event of filling data in an uplink receiver buffer beyond a predetermined threshold.

7. The method of claim 2, wherein the time-critical event is an event of filling data in an uplink receiver buffer beyond a predetermined threshold.

8. The method of claim 3, wherein the time-critical event is an event of filling data in an uplink receiver buffer beyond a predetermined threshold.

9. The method of claim 4, wherein the time-critical event is an event of filling data in an uplink receiver buffer beyond a predetermined threshold.

10. The method of claim 5, wherein the time-critical event is an event of filling data in an uplink receiver buffer beyond a predetermined threshold.

11. The method of claim 6, wherein the time-critical control information is pause information for devices that transmit data on an uplink.

12. The method of claim 7, wherein the time-critical control information is pause information for devices that transmit data on an uplink.

13. The method of claim 8, wherein the time-critical control information is pause information for devices that transmit data on an uplink.

14. The method of claim 9, wherein the time-critical control information is pause information for devices that transmit data on an uplink.

15. The method of claim 10, wherein the time-critical control information is pause information for devices that transmit data on an uplink.

16. A signaling method for a synchronous Ethernet system, comprising the steps of:
detecting a status condition that may effect performance of the synchronous Ethernet system;
if the status condition is detected during a sync frame period, generating control information, inserting the control information into a first sub-sync frame after detection of the situation and transmitting the control information; and
if the status condition is detected during an async frame period, generating a control frame including the control information and transmitting control information.

17. The method of claim 16, wherein the inserting step includes the step of inserting the control information into one of a plurality of sync data slots included in a sync data slot field of the first sub-sync frame after the status condition is detected and transmitting the control information.

18. The method of claim 17, wherein the inserting step includes the step of allocating a flag bit in a header field of the first sub-sync frame after the status condition is detected, setting the flag bit to indicate the control information, and transmitting the control information.

19. The method of claim 18, wherein the flag bit is one bit in a reserved field of the header field.

20. The method of claim 18, wherein the flag bit is allocated by modifying a predetermined field of the header field.
